(19) United States
(12) Patent Application Publication
(10) Pub. No.: US 2013/0198171 A1
(43) Pub. Date: Aug. 1, 2013

(54) METHOD AND SYSTEM FOR MANAGING DATABASE OBJECT INFORMATION

(71) Applicants: Saurin Shah, Redmond, WA (US); Daniel J. Cole, Redmond, WA (US); Mohamed Helal, Redmond, WA (US); Paul Karimov, Redmond, WA (US)

(72) Inventors: Saurin Shah, Redmond, WA (US); Daniel J. Cole, Redmond, WA (US); Mohamed Helal, Redmond, WA (US); Paul Karimov, Redmond, WA (US)

(73) Assignee: Microsoft Corporation, Redmond, WA (US)

(21) Appl. No.: 13/606,802

(22) Filed: Sep. 7, 2012

Related U.S. Application Data
(60) Provisional application No. 61/591,188, filed on Jan. 26, 2012.

(51) Int. Cl. G06F 17/30

(52) U.S. Cl. 707/722; 707/E17.014

(57) ABSTRACT

A method for processing a database object information request includes receiving a database object information request. The database object information request includes a session initiation request and a database object schema retrieval request. The method further includes opening a database object information retrieval session, including assigning a session identifier to the database object information retrieval session, retrieving a result set corresponding to the database object information request, further including assigning a moniker to the result set for use in subsequent database object information retrieval, retrieving the requested database object information using the session identifier and the moniker, and providing a database object information response, the database object information response including the requested database object information.

### CROSS REFERENCE TO RELATED APPLICATIONS

The present application claims priority to U.S. Provisional Patent Application Ser. No. 61/591,188, filed Jan. 26, 2012, the entire content of which is hereby incorporated by reference.

### BACKGROUND

Current desktop database applications allow a user to manipulate data in a variety of ways. A desktop database application can be used to organize and maintain data associated with the many different applications. To access information in a database, a user may utilize a database management application. A database management application may be implemented in software that serves as an interface between the user and a database. The database management application may manage requests for database action. For instance, to facilitate access to information in the database, the database management application typically includes operations to perform searching, querying, sorting, updating and combining data in the database.

### SUMMARY

This summary is provided to introduce a selection of concepts in a simplified form that are further described below in the Detailed Description section. This summary is not intended to identify key features or essential features of the disclosure subject matter, nor is it intended to be used as an aid in determining the scope of the disclosure.

Embodiments of the present disclosure enable methods and systems for insertion and/or modification of database object information at database application at run time. System and methods according to embodiments of the disclosure may be configured to retrieve, display and modify database data via a web browser or standalone database management system. Upon creation of a database application and one or more database objects, systems and methods according to embodiments of the disclosure enable object data to be modified (e.g., inserted, updated, sorted, filtered, and/or deleted) at run-time.

An embodiment of the present disclosure includes a method for processing database object information requests including receiving a database object information request, the database object information request including a session initiation request and a database object schema retrieval request; opening a database object information retrieval session, including assigning a session identifier to the database object information retrieval session; retrieving a result set corresponding to the database object information request, further including assigning a moniker to the result set for use in subsequent database object information retrieval; retrieving the requested database object information using the session identifier and the moniker; and providing a database object information response, the database object information response including the requested database object information.

A further embodiment of the present disclosure includes a computer readable storage medium comprising computer readable instructions for processing database object information requests, comprising: instructions for: receiving a database object information request from a database management system, the database object information request including a session initiation request and a database object schema retrieval request; opening a database object information retrieval session, including assigning a session identifier to the database object information retrieval session; retrieving a result set corresponding to the database object information request, further including assigning a moniker to the result set for use in subsequent database object information retrieval; retrieving the requested database object information using the session identifier and the moniker; and providing a database object information response, the database object information response including the requested database object information.

An additional embodiment of the present disclosure includes computer readable storage medium comprising computer readable instructions for processing database object information requests, comprising: instructions for: sending a database object information request from a database management system, the database object information request including a session initiation request and a database object schema retrieval request; receiving an indication that a database object information retrieval session has been opened, including receiving an assigned session identifier for the database object information retrieval session; receiving a response confirming a result set corresponding to the database object information request has been retrieved, further including receiving a moniker assigned to the result set for use in subsequent database object information retrieval; and receiving a database object information response, the database object information response including the requested database object information retrieved using the session identifier and the moniker.

Embodiments disclosed herein may be implemented as a computer process, a computing system, or an article of manufacture such as a computer program product or computer readable media. The computer program product may be computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures in which:

FIG. 1 illustrates a system for retrieving and modifying database object information according to one or more embodiments;

FIG. 2 illustrates a method for retrieving and modifying database object information according to one or more embodiments;

FIGS. 3A-3B illustrate examples of receiving database object information requests according to one or more embodiments disclosed herein;

FIG. 4 illustrates a tablet computing device executing one or more embodiments disclosed herein;

FIG. 5 illustrates a block diagram of a computing environment suitable for implementing one or more embodiments disclosed herein;

FIG. 6A illustrates one embodiment of a mobile computing device executing one or more embodiments disclosed herein;

FIG. 6B is a simplified block diagram of an exemplary mobile computing device suitable for practicing one or more embodiments disclosed herein; and

FIG. 7 is a simplified block diagram of an exemplary distributed computing system suitable for practicing one or more embodiments disclosed herein.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

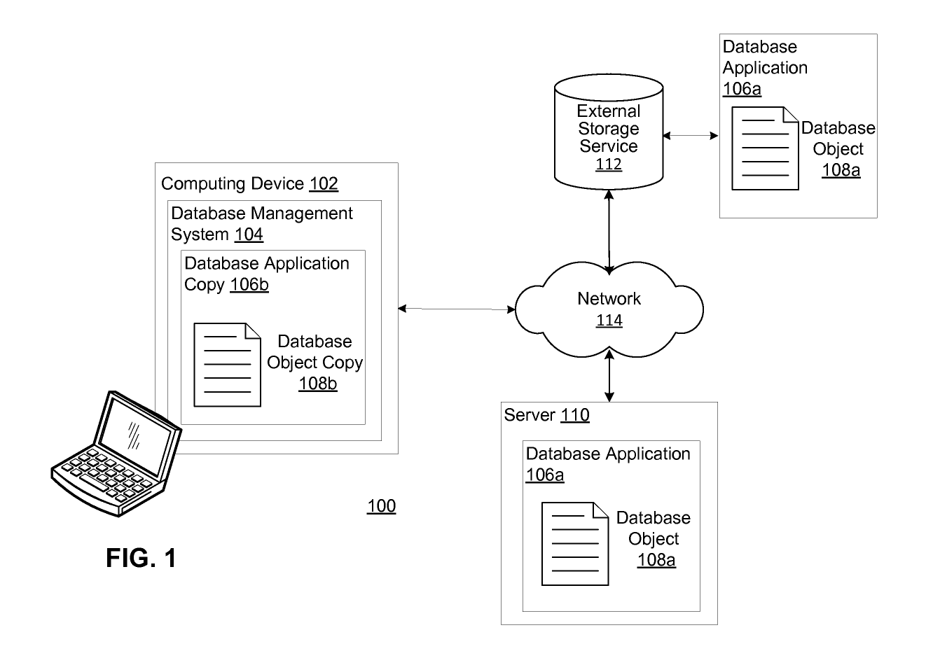

FIG. 1 illustrates a system 100 for retrieving and modifying database object information for a database object of, for example, a database application, via a database management system operating on a computing device according to one or more embodiments. As shown in FIG. 1, the system 100 may be implemented on a computing device 102 (such as a local computing device) including a database management system 104 configured to request information regarding a database application 106a and database object 108a residing on server 110. Database application 106a may be a set of objects, including tables, queries, forms, reports, macros, code modules, etc., that are stored in a database structure. Database object 108a may be any of the tables, queries, forms, reports, macros, code modules, etc., including in a database application. Database management system 104 may be configured to display a temporary local copy of a database application or database object, such as database application copy 106b and database object copy 108b. Database application 106b copy or a database object copy 108b may be retrieved from server 110 to facilitate generation of a request to server 110. In certain embodiments, server 110 may be a relational database management server such as Microsoft®SQL Server® or any database server that supports T-SQL commands. The local computing device 102 may be a desktop or laptop computer, tablet computer, smartphone, personal digital assistant or the like. In certain embodiments, database management system 104 may be a desktop or web-based data management application. In certain embodiments, database management system 104 may be a standard off-the-shelf database management system such as, for example, any version of ACCESS by Microsoft® Corporation of Redmond, Wash. Database management system 104 may support the structured query language (SQL) for querying, updating, and managing the database. In addition to supporting SQL, database management system 104 may further provide extensions to SQL as well as additional user interface features to simplify operations on a database.

As shown in FIG. 1, the system may also enable server 110 to access an external storage service 112 storing a database object 108. Server 110 may be configured to access the external storage service 112 that stores one or more database applications, such as database application 106a, or one or more database objects, such as database object 108a to obtain information or definitions associated with a database object. In order to access the external storage service 112, server 110 may be required to access a network 114. In certain embodiments, the external storage service 112 may be a cloud computing storage service, a file hosting service, or other such service offered by a third party. Examples of such services include SKYDRIVE, SHAREPOINT®, MySite by Microsoft Corporation of Redmond, Wash., DROPBOX by Officeware Corporation, and the like. Although specific examples have been given, it is contemplated that other external storage services may be used with embodiments disclosed herein.

Server 110 may be configured to receive requests to retrieve or modify database object information. Database object information or data may include any data associated with a database object (e.g., a table, form, etc.) maintained within server 110 or within external storage service 112. Database object information may be organized into rows and/or columns and may be associated with one or more object fields (e.g., table categories relevant to the subject matter of the table). Server 110 may support operations to retrieve and edit data in a database application 106a or object 108a, and also include support for multi-user access, data integrity, and security functions for various database applications. Server 110 may also store and retrieve data as requested by applications, including database management system 104. Such applications may reside on the computing device 102 or on another computing device (not shown) configured to communicate with server 110 over a network 114 (e.g., the Internet). Additionally, embodiments may enable server 110 to receive a database object information request from database management system 104 and provide the requested database object information to database management system 104. Server 110 may also be configured to periodically send updates regarding the status of the database object information requests to the computing device 102 in response to one or more requests submitted by database management system 104. Accordingly, server 110 may be configured to communicate with database management system 104 and return the results of the query to the database management system 104. The server 110 and any related operations may be implemented as a web service and may use a standard Internet-based communication protocol such as Hypertext Transfer Protocol (HTTP) or Hypertext Transfer Protocol Secure (HTTPS). Alternatively, requests sent from database management system 104 to server 110 may be in the form of one or more application programming interface (API) calls. To this end, one or more customized database management system APIs may be installed on server 110. Typically, server 110 receives a request from database management system 104 and controls execution of the requested API and returns the results to database management system 104.

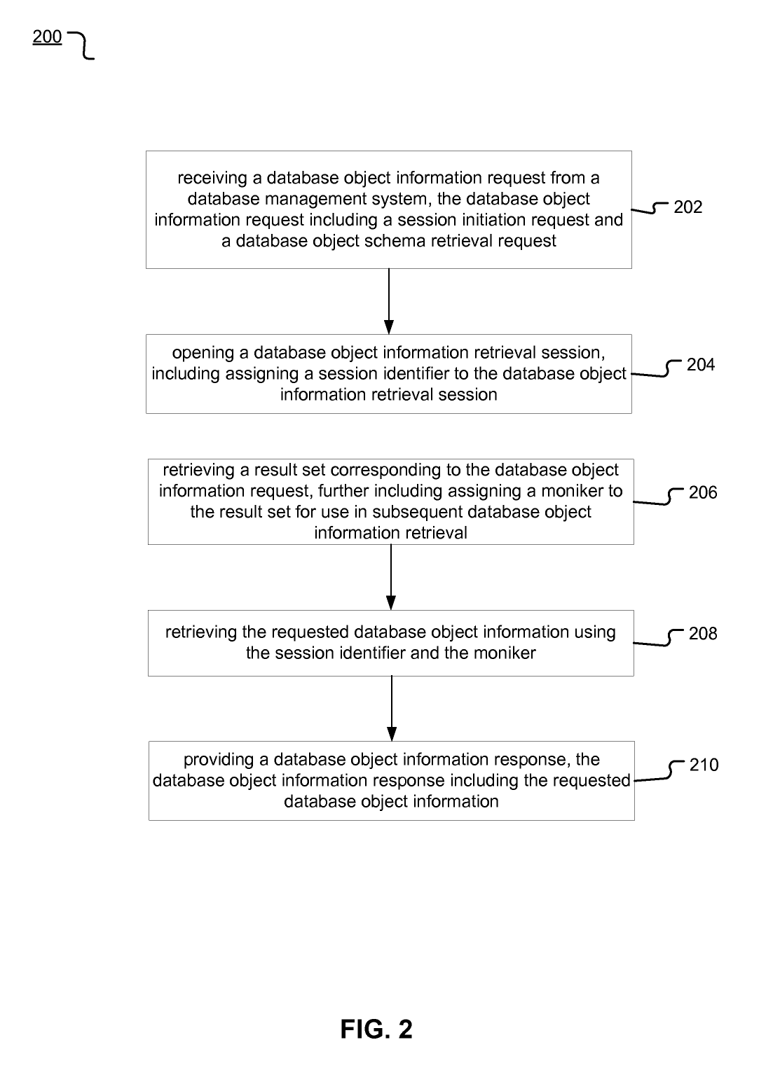

FIG. 2 illustrates a method 200 for retrieving and modifying database object information according to one or more embodiments. Method 200 may be implemented via system 100 described above. Method 200 may provide database object information retrieval and management. Method 200 may include transmitting messages to and from a remote computing device (e.g., server 110 of FIG. 1) to process database object information requests received from a client (e.g., database management system 104 of FIG. 1). Method 200 may provide manipulation of database object data for database objects (e.g., database object 108a of FIG. 1) maintained on the remote computing device or an external storage service (e.g., external storage service 112 of FIG. 1). A database management system running on a local computing device (e.g., computing device 102 of FIG. 1) may initiate communication to the remote computing device requesting database object information. A database object information request may be to retrieve, insert, update, filter, sort, or delete data from a database object. For instance, a request message may include a request to open a result set, a request to update data in a database application, or a request to delete data from a database object.

Method 200 enables a database management system to send a request to access data on a remote computing device, and receive a corresponding response from the remote computing device. Specifically, method 200 may include transmitting messages to and from the remote computing device to process database object information requests received from the database management system and provide database object information to the database management system. Method 200 may transport request messages via transport applications. For instance, request messages may be transmitted via HTTP, or HTTPS. The remote computing device may be configured to listen for HTTP or HTTPS requests, and the database management system may be configured to transmit messages formatted such that they may be received and processed by a server component. The database management system may be configured to send requests via a request URI recognizable by the remote computing device. In some embodiments, the database management system may send a first query to a first component of the remote computing device. In such embodiments, messages sent from the database management system to a first component of the remote computing device may be formatted as JavaScript Object Notation (JSON) messages. In some embodiments, JSON messages may be transmitted to a first remote computing device component configured to reformat the message for processing by the server.

First remote computing device component may send a second query to a second remote computing device component to access a shared database and retrieve the requested information. In certain embodiments, the second query is formatted using a Simple Object Access Protocol (SOAP) message. Database object information requests and responses may be transmitted to and from a second remote computing device component using the simple object access protocol (SOAP). SOAP messages may include a transport envelope (such as an HTTP or JMS envelope, or the like), a SOAP envelope, a SOAP header and a SOAP body. SOAP messages may be formatted using the Web Services Description Language (WSDL). WSDL, as used herein, includes an XML format for describing network services (often web services) as a set of endpoints operating on messages containing either document-oriented or procedure-oriented information. The operations and messages may be described abstractly, and then bound to a network protocol and message format to define an endpoint. Related endpoints may be combined into abstract endpoints (services). WSDL is extensible to allow description of endpoints and their messages regardless of what message formats or network protocols are used to communicate. A WSDL definition may be an XML schema that defines the interface, location and encoding scheme for a database application. The definition defines the application, identifies the port through which the application may be accessed (such as an Internet address), and defines the bindings (such as Enterprise Java Bean or SOAP bindings) that are used to invoke the database application and communicate with the application. Responses to the database management system may then be reformatted as JSON messages for processing by the database management system. The data sent to the database management system from the remote computing device is intended to be rendered for end user viewing.

Method 200 begins at operation 202, in which a remote computing device receives a database object information request for an object in a database application. The database object information request may include a session initiation request and a database object schema retrieval request. For instance, a client application (e.g., database management system 106) may query a remote computing device (e.g., server 110) to call an OpenSession operation and a runtime request (e.g., a GetObjectSchema operation) to retrieve database object information.

A database application may be a blank database configured to receive one or more database objects or an external storage service (e.g., Microsoft® SharePoint®) sub-site connected to a SQL database. A database object may be any data structure suitable for organizing or managing database information (e.g., in rows and columns of a table). Non-limiting examples of a database object may include a form, a table, a query, or a macro. One or more database object information request parameters may also be received by the remote computing device. Parameters may specify information provided to the remote computing device to retrieve the database object information. Data request may be transmitted via an HTTP POST in a format as described above. For instance, data request may be a JSON request message sent by the database management system including an object and one or more specified object elements for which data is requested. In certain embodiments, data request may specify one or more objects (e.g., rows of data) to be retrieved and may further specify information about the objects to be retrieved from database application. Request body may include one or more input elements specifying an object source, an object name, or other object field data to be retrieved from a source.

A source may be an updatable source (e.g., a source in a database application against which insert, update, and delete data operations are applied). Further, if a query includes more than one source to be updated, the sources may be joined in the query. For instance, a source join may be specified by a join element (e.g., by a CT_Join element). To join the sources, the client may call the source specified in a first attribute (e.g., a Left attribute SL), and the source specified in a second attribute (e.g., a Right attribute SR), a property specified in the first attribute property (e.g., the property specified in a LeftProperty attribute PL), a property specified in a second property attribute (e.g. a property specified in a RightProperty attribute PR) and a join type specified in a type attribute (e.g., a join type specified in a Type attribute “T”). In some instance, for the query to be updatable, a property can only be part of one join element. The query is updatable if there exists a source that is updatable in relation to all of the sources to which the query is connected (e.g., in a source graph for the query).

Upon receiving a database object information request, flow proceeds to operation 204 in which a database object information retrieval session is opened. Opening a database object information retrieval session may include assigning a session identifier to the database object information retrieval session. A session may be opened on the remote computing device, and a session identifier (e.g., sessionID) may be assigned to the session. Upon opening a query session, flow proceeds to operation 206 in which the remote computing device may retrieve a result set corresponding to the database object information request. Retrieving a result set may further include assigning a moniker to the result set for use in subsequent database object information retrieval. In some embodiments, a schema request (e.g., a GetObjectSchema) operation may create a new result set on the current session and assign a unique identifier (e.g., moniker or any type of string that specifies an identifier) for the result set.

Upon retrieving a result set, flow proceeds to operation 206, in which the remote computing device retrieves the requested database object information using the session identifier and the moniker. Database object information may be retrieved from a source (e.g., a named query or a table in a database application). It is contemplated that remote computing device may retrieve object data from a specified source such as an external storage service and provide a response to the database management system. The client application may then call any other runtime operations using the moniker and the sessionID elements so that requested operations are performed on the same result set. It the client is attempting to retrieve data from another source in a database application, the client may call GetObjectSchema operation with the object name passed in the source input element. This operation may create another result set in the same session, without having to call OpenSession, and the result set may be assigned a new moniker. Additional request operations may include a CloseSession operation, a DeleteData operation, a FixupRow operation, a GetData operation, a GetDistinctValues operation, an InsertData operation, a KeepAlive operation, an OpenResultSet operation, and an UpdateData operation, which will be discussed further below.

Upon retrieving a result set, flow proceeds to operation 208, in which the remote computing device provides a database object information response. The database object information response may include the requested database object information. For instance, upon processing the request, the remote computing device may provide a result subset including one or more values representing the requested object information. In some embodiments, the client application may request a subset of the rows in a result set by specifying a starting index and a maximum row count to return. A result subset may then be a set of rows that results from running a query specified by a source (e.g., the requested rows of data) retrieved from the specified source. Remote computing device may then return the requested database application data. Returned data may be in the form, for example, of one or more rows. The response may specify a number of rows and, if applicable, a number of pages comprising the returned data. Remote computing device may also return the schema information of the requested fields. Remote computing device may further return an error result if processing the request results in an application error.

In some embodiments, upon receiving the database object information request and parameters, the remote computing device may verify the database object information request. In further embodiments, one or more remote computing device components may be provisioned and configured to receive the database object information request. Remote computing device may verify that a database object information request is properly formatted and includes the elements necessary to process the request, as will be discussed further below. To provide a response message, remote computing device may process the database object information request, retrieve the requested data, from the remote computing device (e.g., stored on the remote computing device), or from an external storage service, and provide a JSON response including the requested data. A response message may also include a database object information request status. The response message may include an indication that the database object information request was successful. In some embodiments, the response message may specify database object information, including one or more database object definitions for the database object. For instance, the remote computing device may provide a string specifying a fully qualified uniform resource locator (URL) to the database object.

Returned data may be filtered if a filter request was also specified in the request message body. Remote computing device may receive a request to filter returned data. Remote computing device may process the request and determine if one or more filter elements or restriction input elements are valid. Data may be filtered according to one or more received filter elements or restriction input elements. For instance, data may be filtered by expression or text, or both. Filtering by expression may specify one or more conditions requested to be satisfied for every row of the result set. Filtering by text may specify one or more search terms requested to be present in every row of the result set in any of the fields. Returned data may also be sorted if a sort request was also specified in the request message body. Remote computing device may receive a request to sort returned data. Remote computing device may process the request and determine if one or more sort elements or restriction input elements are valid. Data may be sorted according to one or more received sort elements or restriction input elements.

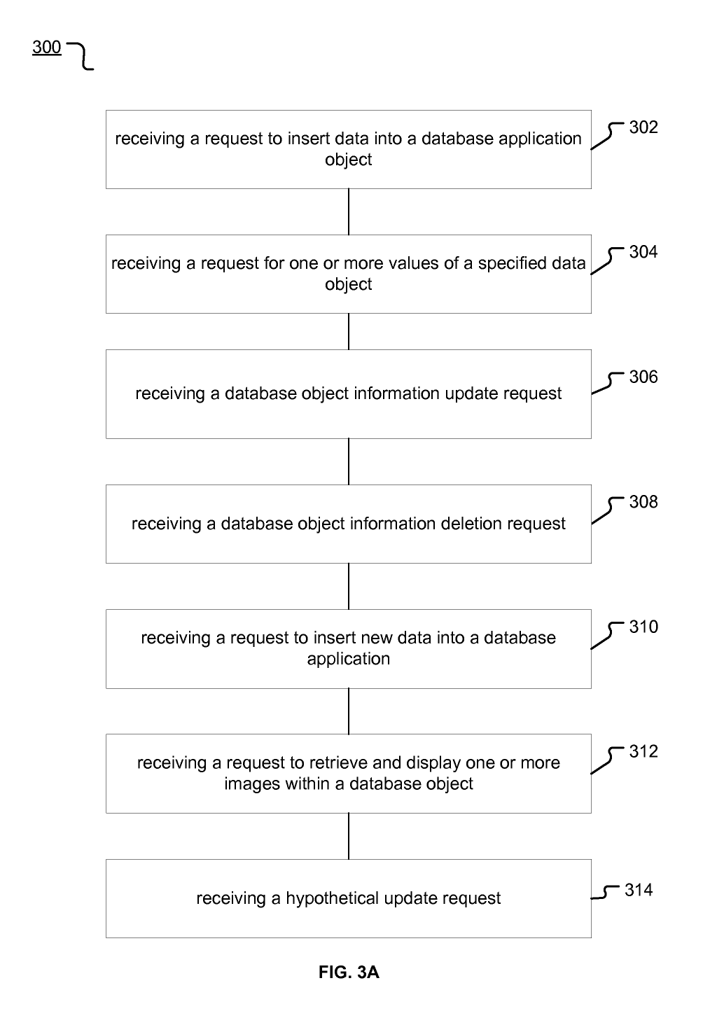

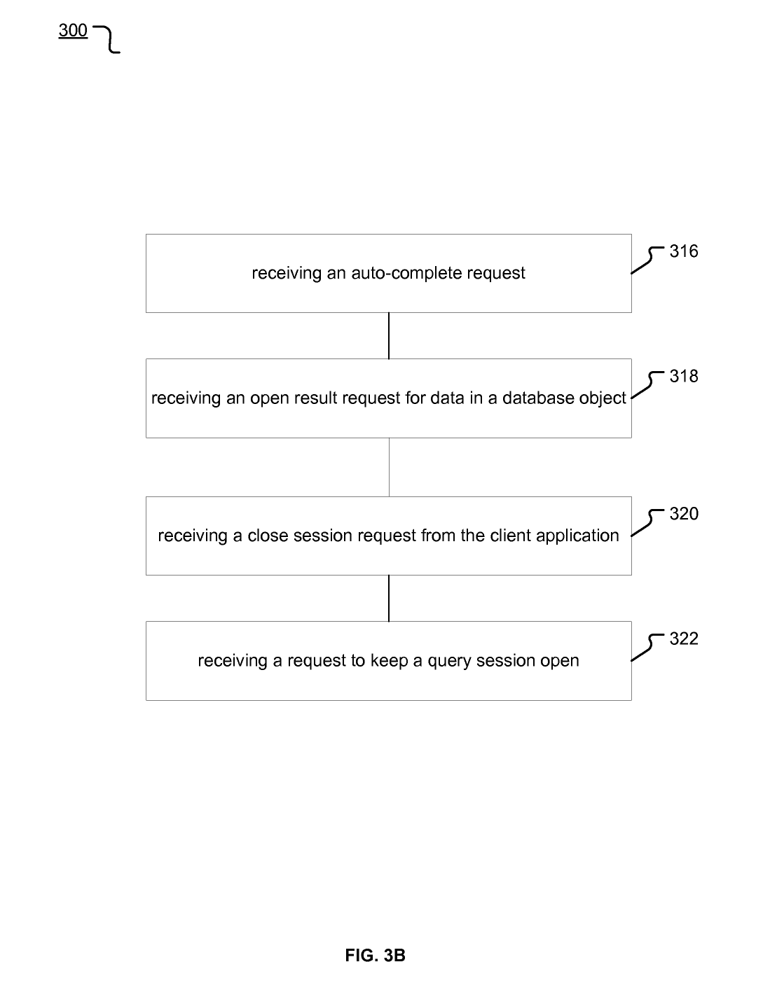

FIGS. 3A-3B illustrate examples 300 of data object information requests that may be received and processed by the remote computing device in step 202 of method 200. It is to be understood that none of the examples illustrated in FIGS. 3A-3B are dependent upon another example or are necessarily required to execute prior to execution of a subsequently numbered example. The numbering provided is for reference only. In some embodiments, receiving 202 a database object information request may include receiving 302 a request a request to insert data into a database application object. This operation inserts a record into a table in the database application and also inserts a row into the result set returned by the query. A user may view a table of data via a stand-alone database management system or a web-based management system. The user may be able to insert records into a database object. To perform data insertion, remote computing device may receive a request message including a source and an update record request for a referenced database application object. Remote computing device may process the request and provide a response including a record value containing a record of the data inserted by remote computing device. Insert data request may specify the values for one or more fields of the records to be inserted into the database application. Remote computing device may return the values of successfully inserted records. Remote computing device result message may include a values element in the result message body. Result message body may further specify one or more records updated by remote computing device in response to the insert record request. Remote computing device may insert one or a collection of records into the database application object based on the insert record request. Remote computing device may retrieve values for one or more fields of the new records and insert the new values into the database application. Remote computing device may then assign a value to one or more fields of the inserted records and retrieves field values from the database application and returns the field values in the response message body. Another user (e.g., a user with permission) may access the database object, for instance, via the web, and may also update records. In such instances, similar processing as above may occur.

In some embodiments, receiving 202 a database object information request may include receiving 304 a request for one or more values of a specified data object. This operation performs sort, filter, and synchronization operations on rows in the result set, and returns a subset of those rows. Remote computing device may receive a request for a distinct value of a database object component (e.g., of a data column in a database application table) from the database management system. Request may specify a source and a distinct value command. Remote computing device may retrieve records with distinct values from a source and return the values in a body of a response message. Remote computing device may return the requested distinct values. Remote computing device response message may include a values element in the result message body further including the records from the specified source, which further include the distinct values requested by the database management system. Response message may further specify one or more rows containing the requested distinct field values.

In some embodiments, receiving 202 a database object information request may include receiving 306 a database object information update request. This operation updates a record in an updatable source in the database application and also updates the row in the result set returned by the query. Remote computing device may receive a request message including a source and an update record request for a referenced database object. Remote computing device may process the request and provide a response including a record value containing the records of data inserted by remote computing device. Source and update record request may determine the values for one or more fields of the records to be inserted into the database application. The remote computing device may return the values of successfully updated records. Remote computing device result message may include a values element in the result message body. The result message body may further specify one or more records updated by remote computing device in response to the insert record request. The remote computing device may update one or a collection of records into the database application based on the update record request. The remote computing device may retrieve values for one or more fields of the new records and insert the new values into the database application. The remote computing device may then assign a value to one or more fields of the updated records and retrieves field values from the database application and returns the field values in the response message body.

In some embodiments, receiving 202 a database object information request may include receiving 308 a database object information deletion request. This operation deletes a record from a table in the database application and also deletes the corresponding row from the result set returned by the query. The remote computing device may receive a request message including a source and a delete record request for a referenced database object. The remote computing device may process the request and provide a response including a record value containing a record of data deleted by remote computing device. A delete record request may determine the values for one or more fields of the records to be deleted. The remote computing device may return the values of successfully updated records. The remote computing device result message may include a values element in the result message body. The result message body may further specify one or more records deleted by remote computing device in response to the delete record request. The remote computing device may update one or a collection of records into the database application based on the delete record request. The remote computing device may then return the remaining records after requested record has been deleted.

In some embodiments, receiving 202 a database object information request may include receiving 310 a request to insert new data into a database application. The remote computing device may retrieve values for one or more fields of the new records and insert the new values into the database application. The remote computing device may add a new record into the updatable source of the database application with the fields of the record filled in as specified by the values element in an insert element (e.g., in an InsertData element). If the record was successfully inserted, the remote computing device may retrieve the inserted record from the database application and add a row to the result set with a primary key equal to a primary key of the record, and with columns filled in as specified by the corresponding columns of the retrieved record. The remote computing device may then return the newly added row to the client (e.g., database management system 104).

In some embodiments, receiving 202 a database object information request may include receiving 312 a request to retrieve and display one or more images within a database object. The client (e.g., database management system 104) may request one or more image fields configured to display an image retrieved from remote computing device. The remote computing device may receive a request to display an image within a database object (e.g., a field in a database application table) from the database management system. The request may specify a source and a distinct value command for the image. The remote computing device may retrieve the image corresponding to the requested values from a source (e.g., an SQL server, or rich client application) and the image may display within the database object on the database management system. For instance, server 110 may return one or more rows having only fields from the result set that contain image data (e.g., specified by a startRowIndex command from the client).

In some embodiments, receiving 202 a database object information request may include receiving 314 a hypothetical update request. A hypothetical update may be a hypothetical object information update that does not affect the object information of the specified object stored on the remote computing device or external storage service. The remote computing device may receive a request to provide a hypothetical update for one or more database application components. The remote computing device may retrieve a copy of a row from the database application using the updatable source, which was previously supplied as the source input element to the GetObjectSchema Operation described above, and a given key. In some embodiments, the database management system may send the hypothetical modeling request, and may specify one or more fields of the database component to be used when providing the hypothetical update. Fields may be fields of an updatable source application. The remote computing device may return a hypothetical update to the database management system based on the specified fields. A hypothetical update may only update the temporary copy of the database application (e.g., database application copy 106b). The remote computing device may update the columns specified in values in the copy. Neither the database application nor the result set may be modified. Returned data may not be inserted into or updated in the database application stored on the server or external storage service, but may be viewed in the copy of the database application residing within the database management system. If the update succeeds, the remote computing device returns the updated values of all columns in the row.

Remote computing device may also receive a format request specifying the format for a field used in the hypothetical update, and may be configured to utilize the specified format to verify the field and format the field prior to returning a hypothetical modeling update to the database management system. Remote computing device may return the resulting values of the hypothetical update to the database management system. In some embodiments, remote computing device may receive a JSON request including a specified record to be hypothetically updated including, for example, a database application and one or more specified database objects to be hypothetically updated. Remote computing device may process the request and return a JSON response including a result for the specified record. Result may also include one or more updated values for the specified record.

In some embodiments, receiving 202 a database object information request may include receiving 316 an auto-complete request for data in a database object. A database object such as a table may include one or more fields including database data. A field may include a reference to one or more other objects. Database object information may be inserted or updated within a field of a current object having a reference to another object by providing auto-completion of the field name to be inserted or updated. Upon receiving an input of at least one initial character of the field via the database management system, remote computing device may retrieve one or more potential field matches and return the field results to the database management system. Results may be returned in a list or record, and may be selectable by a user to insert or update the field.

In some embodiments, receiving 202 a database object information request may include receiving 318 an open result request for data in a database object. This operation opens a result set for a given source and returns a subset of rows from the result set. The client may send an open result set request including one or more specified fields of a source for results to be opened. The remote computing device may retrieve the data from a source of the database application, which may be the same source specified when the query session was opened. The remote computing device may response with a response message including a returned subset of rows. The remote computing device may return a subset of rows specified by one or more parameter input elements such as a startRowIndex and a maximumRows input elements. The fields specified by fields input element may be retrieved. The data may also be filtered according to one or more filter and restriction input elements. The remote computing device may also sort the data according to one or more expressions defined by a sort expression input element. The remote computing device may store the data in a result set identified by the moniker input element within the session identified by a identifier such as a WorkbookId element of the parameter input element in the request message.

When a query session has completed, the remote computing device may receive 320 a close session request from the client application. For instance, the remote computing device may receive a CloseSession operation. Remote computing device may then send a close session response to the client application, and the session may be closed. In some embodiments, a session may time out automatically after a set period of time. If a user desires to keep a session open longer, remote computing device may be configured to receive 322 a request to keep a query session open keep a query session alive. This operation extends the time a session has remaining before it times out. According to some embodiments, a client may send a KeepAlive message to the remote computing device. The remote computing device may receive the message and reset the time remaining for the session specified in, for example, a parameter of a session reset element (e.g., a WorkbookId element in a parameter element in a KeepAlive element) to its original timeout value. The remote computing device may then send a keep alive response message indicating that the session time has been reset.

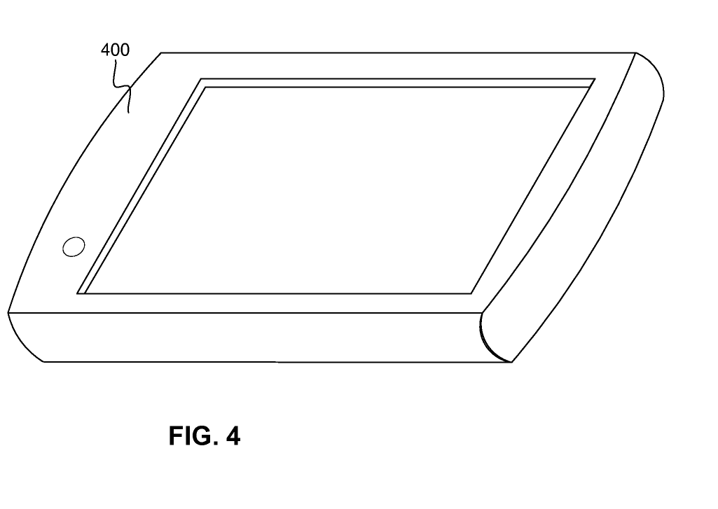

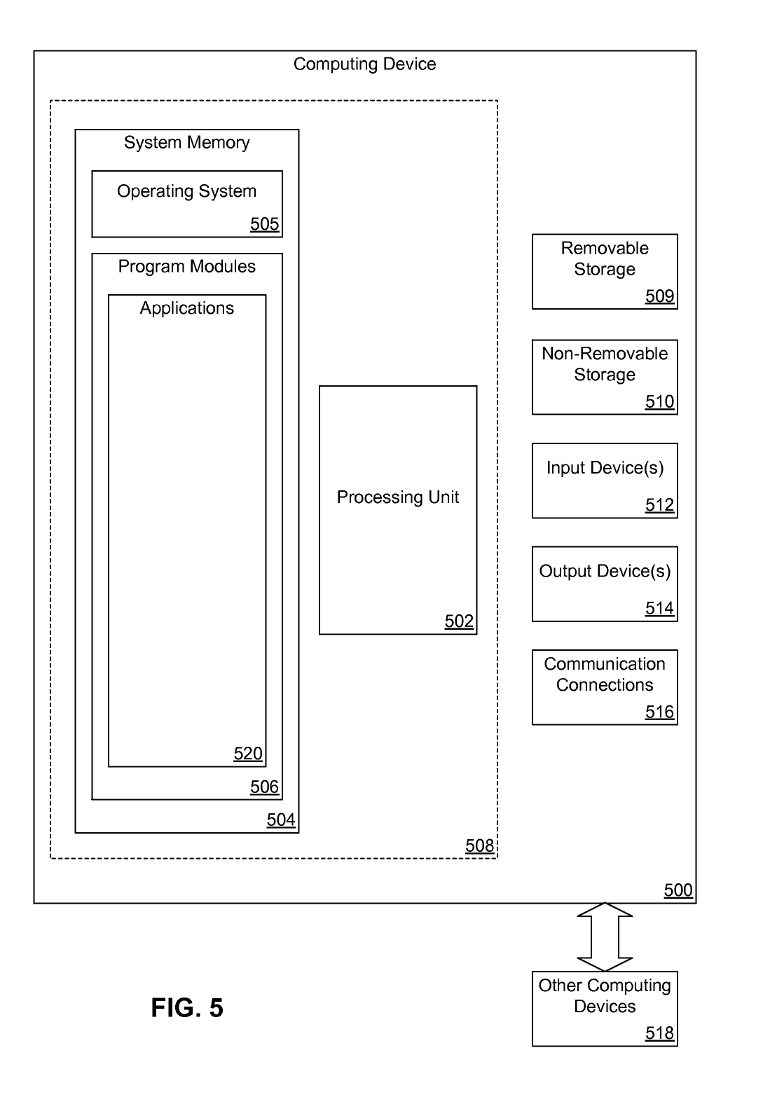

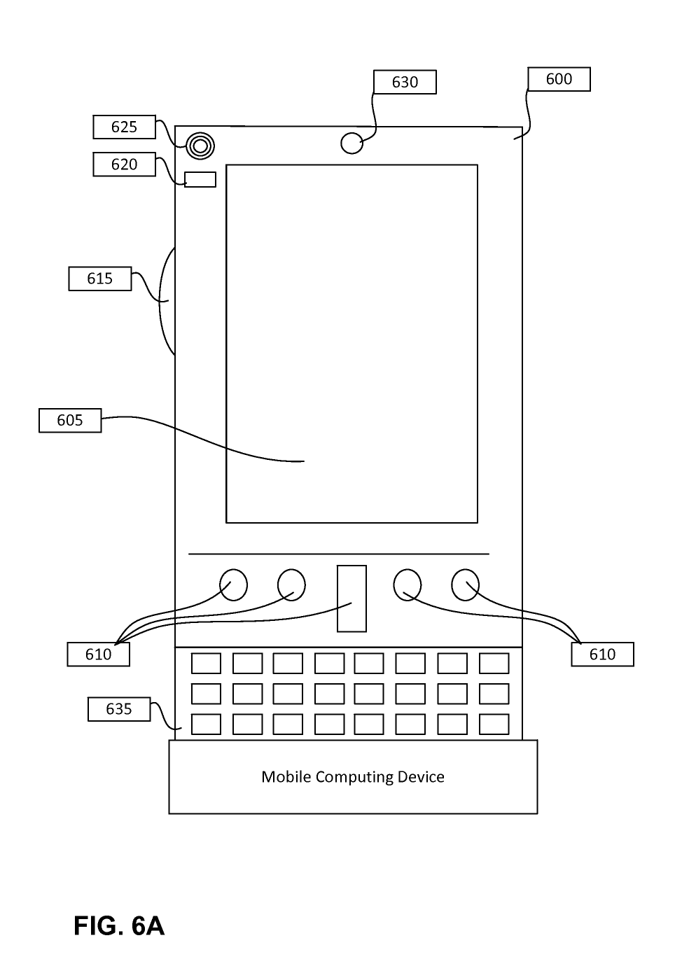

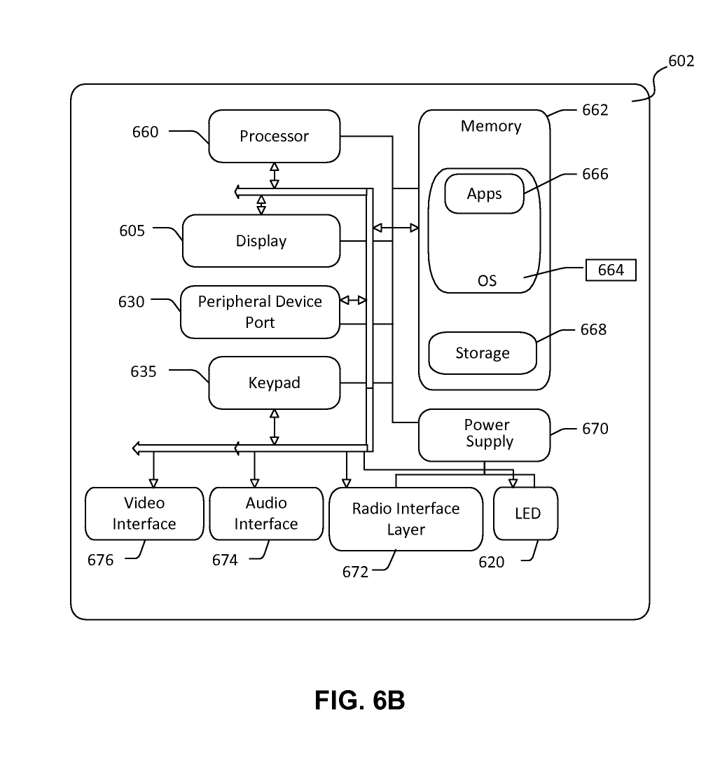

The embodiments and functionalities described herein may operate via a multitude of computing systems including, without limitation, wired and wireless computing systems, mobile computing systems (e.g., mobile telephones, netbooks, tablet or slate type computers, and laptop computers). FIG. 4 illustrates an exemplary tablet computing device 400 executing an embodiment of the paragraph property detection engine 103. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 5 through 8 and the associated descriptions provide a discussion of a variety of operating environments in which embodiments of the present disclosure may be practiced. However, the devices and systems illustrated and discussed with respect to FIGS. 6 through 8 are for purposes of example and illustration and are not limiting of a vast number of computing device configurations that may be utilized for practicing embodiments of the present disclosure, described herein.

FIG. 5 is a block diagram illustrating exemplary physical components of a computing device 500 with which embodiments of the present disclosure may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination. The system memory 504 may include an operating system 505, one or more program modules 506, which are suitable for running applications 520. The operating system 505, for example, may be suitable for controlling the operation of the computing device 500. Furthermore, embodiments of the present disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including, for example, one or more of the stages of the methods described herein. The aforementioned process is an example, and the processing unit 502 may perform other processes. Other program modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the present disclosure, program modules may include routines, programs, components, data structures, and other types of structures that may perform particular tasks or that may implement particular abstract data types. Moreover, embodiments of the present disclosure may be practiced with other computer system configurations, including hand-held devices, multiprocessor systems, microprocessor-based or programmable consumer electronics, minicomputers, mainframe computers, and the like. Embodiments of the present disclosure may also be practiced in distributed computing environments where tasks are performed by remote processing devices that are linked through a communications network. In a distributed computing environment, program modules may be located in both local and remote memory storage devices.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the present disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may be operated via application-specific logic integrated with other components of the computing device 500 on the single integrated circuit (chip). Embodiments of the present disclosure may also be practiced using other technologies capable of performing logical operations such as, for example, AND, OR, and NOT, including but not limited to mechanical, optical, fluidic, and quantum technologies. In addition, embodiments of the present disclosure may be practiced within a general purpose computer or in any other circuits or systems.

Embodiments of the present disclosure, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 504, the removable storage device 509, and the non-removable storage device 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Additionally, a computer storage device may be any type of computer storage media, including, but not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media or computer storage device may be part of the computing device 500. The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, or serial ports, and other connections appropriate for use with the applicable computer readable media.

FIGS. 6A and 6B illustrate a mobile computing device 600, for example, a mobile telephone, a smart phone, a tablet personal computer, a laptop computer, and the like, with which embodiments of the present disclosure may be practiced. With reference to FIG. 6A, an exemplary mobile computing device 600 for implementing the embodiments is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

Although described herein in combination with the mobile computing device 600, in alternative embodiments, features of the present disclosure may be used in combination with any number of computer systems, such as desktop environments, laptop or notebook computer systems, multiprocessor systems, micro-processor based or programmable consumer electronics, network PCs, mini computers, main frame computers and the like. Embodiments of the present disclosure may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present disclosure.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world”, via a communications carrier or service provider. Transmissions to and from the radio 672 are conducted under control of the operating system 664. In other words, communications received by the radio 672 may be disseminated to the application programs 666 via the operating system 664, and vice versa.

The radio 672 allows the system 602 to communicate with other computing devices, such as over a network. The radio 672 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 602 provides notifications using the visual indicator 620 that can be used to provide visual notifications and/or an audio interface 674 producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668. Computer storage media may include volatile and nonvolatile, removable and non-removable media implemented in any method or technology for storage of information, such as computer readable instructions, data structures, program modules, or other data.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

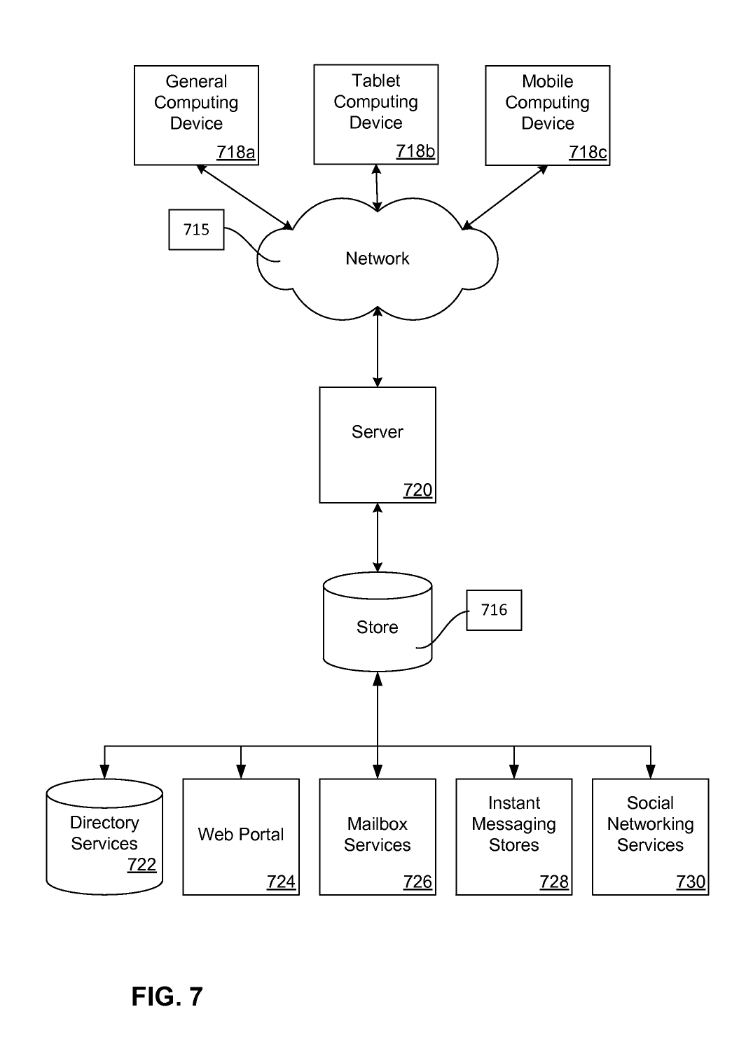

FIG. 7 illustrates one embodiment of the architecture of a system for providing converted documents to one or more client devices, as described above. In certain embodiments, the converted documents may be stored in different communication channels or other storage types. For example, various documents, including the converted documents, may be stored using a directory service 722, a web portal 724, a mailbox service 726, an instant messaging store 728, or a social networking site 730. The various components of the system 100 use any of these types of systems or the like for enabling data utilization, as described herein. A server 720 may provide the converted paragraphs to clients. The server 720 may provide the converted paragraphs and the status updates over the web to clients through a network 715. By way of example, the client computing device 718 may be implemented as the computing device 700 and embodied in a personal computer 718a, a tablet computing device 718b and/or a mobile computing device 718c (e.g., a smart phone). Any of these embodiments of the client computing device 718 may obtain content from the store 716. In various embodiments, the types of networks used for communication between the computing devices that make up the present disclosure include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

One skilled in the relevant art may recognize, however, that the embodiments may be practiced without one or more of the specific details, or with other methods, resources, materials, etc. In other instances, well known structures, resources, or operations have not been shown or described in detail merely to avoid obscuring aspects of the embodiments.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed:

1. A method for processing database object information requests comprising:
receiving a database object information request, the database object information request including a session initiation request and a database object schema retrieval request;
opening a database object information retrieval session, including assigning a session identifier to the database object information retrieval session;
retrieving a result set corresponding to the database object information request, further including assigning a moniker to the result set for use in subsequent database object information retrieval;
retrieving the requested database object information using the session identifier and the moniker; and
providing a database object information response, the database object information response including the requested database object information.

2. The method of claim 1, wherein the database object information request is a request to return filtered data in response to the database object information request.

3. The method of claim 2, wherein the database object information response includes filtered returned data.

4. The method of claim 1, wherein the database object information request is a request to retrieve and display one or more images within a database object, the request specifying a source and a distinct value for the one or more images.

5. The method of claim 4, wherein the database object information response includes retrieval of the image corresponding to the distinct value from the source suitable for display within the database object.

6. The method of claim 1, wherein the database object information request is a request to auto-complete a field in a database object having a reference to a second database object.

7. The method of claim 6, further including:
accessing the second database object; and
retrieving and returning one or more potential field matches.

8. The method of claim 1, wherein the database object information request is a request to receive a hypothetical update for a database component, the request specifying one or more fields of the database component to be used when providing the hypothetical update.

9. The method of claim 8, further including:
retrieving a copy of the database component the database application using an updatable source; and
returning a hypothetical update based on the one or more specified fields, the hypothetical update only updating a temporary copy of the database application.

10. A computer readable storage medium comprising computer readable instructions for processing database object information requests, comprising: instructions for:
receiving a database object information request from a database management system, the database object information request including a session initiation request and a database object schema retrieval request;
opening a database object information retrieval session, including assigning a session identifier to the database object information retrieval session;
retrieving a result set corresponding to the database object information request, further including assigning a moniker to the result set for use in subsequent database object information retrieval;
retrieving the requested database object information using the session identifier and the moniker; and
providing a database object information response, the database object information response including the requested database object information.

11. The computer readable storage medium of claim 10, wherein the database object information request is a request to return filtered data in response to the database object information request.

12. The computer readable storage medium of claim 11, wherein the database object information response includes filtered returned data.

13. The computer readable storage medium of claim 10, wherein the database object information request is a request to retrieve and display one or more images within a database object, the request specifying a source and a distinct value for the one or more images.

14. The computer readable storage medium of claim 13, wherein the database object information response includes retrieval of the image corresponding to the distinct value from the source suitable for display within the database object.

15. The computer readable storage medium of claim 10, wherein the database object information request is a request to auto-complete a field in a database object having a reference to a second database object.

16. The computer readable storage medium of claim 15, wherein the database object information response includes:
accessing the second database object; and
retrieving and returning one or more potential field matches.

17. The computer readable storage medium of claim 10, wherein the database object information request is a request to receive a hypothetical update for a database component, the request specifying one or more fields of the database component to be used when providing the hypothetical update.

18. A computer readable storage medium comprising computer readable instructions for processing database object information requests, comprising: instructions for:
sending a database object information request from a database management system, the database object information request including a session initiation request and a database object schema retrieval request;
receiving an indication that a database object information retrieval session has been opened, including receiving an assigned session identifier for the database object information retrieval session;
receiving a response confirming a result set corresponding to the database object information request has been retrieved, further including receiving a moniker assigned to the result set for use in subsequent database object information retrieval; and
receiving a database object information response, the database object information response including the requested database object information retrieved using the session identifier and the moniker.

19. The computer readable storage medium of claim 17, wherein the database object information request is a request to auto-complete a field in a database object having a reference to a second database object.

20. The computer readable storage medium of claim 19, further including:
receiving one or more potential field matches; and
receiving a selection of the one or more potential field matches for auto-completing the field.
